(19) United States
(12) Patent Application Publication
(10) Pub. No.: US 2024/0161332 A1
(43) Pub. Date: May 16, 2024

(54) GLASSES DEVICE AND METHOD FOR DETERMINING A POSE

(71) Applicant: Robert Bosch GmbH, Stuttgart (DE)

(72) Inventors: Johannes Meyer, Haseluenne (DE); Thomas Alexander Schlebusch, Renningen (DE)

(21) Appl. No.: 18/473,139

(22) Filed: Sep. 22, 2023

(30) Foreign Application Priority Data
Nov. 10, 2022 (DE) 102022211923.1

(51) Int. Cl. G06T 7/70; G02B 27/01; G06F 3/01

(52) U.S. Cl. CPC G06T 7/70; G02B 27/017; G06F 3/011; G02B 2027/0178

(57) ABSTRACT

A glasses device. The glasses device includes a frame structure for fixing the glasses device to a head of a user, at least one at least partially transparent vision element, which can be positioned in front of at least one eye of the user and through which the user can look, and at least one sensor arrangement arranged on the frame structure. The sensor arrangement is configured to capture sensor data while the user wears the glasses device. The sensor data at least partially represent at least one subarea of a body of the user during the wearing of the glasses device. A pose determination of a pose of the user can be carried out based on the sensor data.

### CROSS REFERENCE

The present application claims the benefit under 35 U.S.C. § 119 of German Patent Application No. DE 10 2022 211 923.1 filed on Nov. 10, 2022, which is expressly incorporated herein by reference in its entirety.

### FIELD

The present invention relates to a glasses device configured to capture sensor data of a user of the glasses device. Furthermore, the present invention relates to a method for determining a pose of the user based on the sensor data of the glasses device.

### BACKGROUND INFORMATION

Various methods for determining poses of persons are described in the related art. Furthermore, devices for capturing sensor data for determining poses are also described in the related art.

It is an object of the present invention to provide an improved glasses device and an improved method for determining a pose of a user of the glasses device.

This object may be achieved by the glasses device and the method for determining a pose of a user according to the present invention. Advantageous configurations of the present invention are disclosed herein.

Provided according to one aspect of the present invention is a glasses device. According to an example embodiment of the present invention, the glasses device comprises a frame structure for fixing the glasses device to a head of a user, at least one at least partially transparent vision element, which can be positioned in front of at least one eye of the user and through which the user can look, and at least one sensor arrangement arranged on the frame structure, wherein the sensor arrangement is configured to capture sensor data while the user wears the glasses device, and wherein the sensor data at least partially represent at least one subarea of the user during the wearing of the glasses device, and wherein a pose determination of a pose of the user can be carried out based on the sensor data.

This can achieve the technical advantage that a glasses device that can be used for determining poses of a user or wearer of the glasses device can be provided. Sensor data that represent subareas of the body of the user can be captured by the sensor arrangement while the user wears the glasses device. Based on these sensor data, a pose determination can subsequently be performed. The glasses device can thus be used for the data capture of the sensor data, which are later used for a corresponding pose determination. The glasses device can also be used directly for the pose determination by the glasses device according to further embodiments furthermore comprising means for performing such a pose determination. A pose of the body of the user determined in this way can subsequently be used for determining a digital avatar of the user.

According to one example embodiment of the present invention, the subarea of the body of the user comprises one or more from the following list: upper body, shoulder, arm, upper arm, forearm, hand, torso, leg, thigh, lower leg, foot.

This can achieve the technical advantage that body parts that are essential for a precise pose determination are represented by the sensor data.

According to one example embodiment of the present invention, the sensor arrangement is at least partially oriented in a viewing direction of the glasses device defined by the vision element and/or at an angle to the viewing direction.

This can achieve the technical advantage that body parts, such as shoulders, arms, upper body and/or legs, that are important for the pose determination can be seen by the sensor arrangement.

According to one example embodiment of the present invention, the frame structure comprises at least one temple element for fixing the glasses device to an ear of the user, wherein the at least one sensor arrangement is arranged at least partially on the temple element.

This can achieve the technical advantage that the formation of the sensor arrangement in the temple element can achieve that the sensor arrangement is not covered/obscured by the nose and/or cheeks and/or hair of the user. Body parts that are important for the pose determination, such as shoulders, arms, upper body and/or legs, can thus be seen by the sensor arrangement without them being obscured.

According to one example embodiment of the present invention, the at least one sensor arrangement is at least partially integrated into a support body of the frame structure and/or of the temple element.

This can achieve the technical advantage that the sensor arrangement is protected from damage as a result of the integration of the sensor arrangement into the support body of the frame structure and/or of the temple element. Moreover, the sensor arrangement can thus be arranged so as not to be visible from the outside. The glasses device can thus be designed like regular glasses so that the user can easily wear the glasses device in everyday life. This makes it possible to capture meaningful sensor data representing the user in everyday situations.

According to one example embodiment of the present invention, the sensor arrangement furthermore comprises at least one deflection device, wherein an orientation of the sensor arrangement can be varied via the deflection device.

This can achieve the technical advantage that, depending on the application, different subareas of the body of the user can be represented by the sensor data. Alternatively or additionally, the orientation of the sensor arrangement can be adjusted depending on the position of the body of the user. Especially during movements of the user, this can achieve that subareas of the body can be represented at any time by the sensor data.

According to one example embodiment of the present invention, the sensor arrangement comprises one or more from the following list: camera sensor, stereo camera sensor, ultrasonic sensor, LiDAR sensor, edge emitter laser assembly, laser feedback interferometry sensor.

This can achieve the technical advantage that precise sensor data can be provided, based on which an exact pose determination can be carried out.

According to one example embodiment of the present invention, the glasses device is designed as one from the following list: glasses, reading glasses, sunglasses, safety glasses, ski glasses, swim goggles, diving goggles.

This can achieve the technical advantage that the glasses device can be realized in a multitude of different types of glasses. The types of glasses are designed as conventional types of glasses. The user can thus easily wear the glasses device in everyday life. As a result, the sensor arrangement can capture genuine sensor data that represent the user in a variety of situations of daily life.

According to one example embodiment of the present invention, the glasses device furthermore comprises a computing unit, wherein the computing unit is configured to ascertain a pose determination of a pose of the user based on the sensor data of the sensor arrangement.

This can achieve the technical advantage that the glasses device is able to carry out a corresponding pose determination entirely independently of external computing units. The pose determination can thus be carried out while the user wears the glasses device.

According to one example embodiment of the present invention, the glasses device furthermore comprises a transmitting/receiving unit, wherein the transmitting/receiving unit is configured to transmit the sensor data of the sensor arrangement to an external computing unit for a pose determination.

This can achieve the technical advantage that the transmitting/receiving unit can already transmit the data to the external computing unit for a pose determination while the user wears the glasses device and while the sensor data are captured. The pose determination can thus take place simultaneously with the data capture. By allowing for the external computing unit, a higher computing power can be used for the pose determination than would be possible by a computing unit integrated into the glasses device.

According to one example embodiment of the present invention, a trained artificial intelligence is formed on the computing unit, wherein the trained artificial intelligence is configured to ascertain a pose of the user based on the sensor data.

This can achieve the technical advantage that the artificial intelligence enables a precise pose determination based on the sensor data.

Provided according to a further aspect of the present invention is a method for determining a pose of a user. According to an example embodiment of the present invention, the method comprises:
receiving sensor data of at least one environmental sensor of a glasses device according to one of the above-described embodiments, wherein the sensor data at least partially represent at least one subarea of a body of a user of the glasses device, and wherein the sensor data were captured while the user wore the glasses device;
performing a pose determination based on the sensor data and determining pose model information regarding a pose of the user of the glasses device; and
providing the pose model information.

This can achieve the technical advantage that an improved method for determining a pose can be provided by utilizing the sensor data of the glasses device according to the present invention with the technical advantages described above. The provided pose model information can furthermore be used to create a digital avatar of the user.

According to one example embodiment of the present invention, the sensor data received comprise lidar data of at least one laser feedback interferometry sensor, wherein performing the pose determination comprises:

performing a laser feedback interferometry analysis and determining distance values and/or velocity values of at least subareas of the subareas of the body of the user represented by the sensor data.

This can achieve the technical advantage that the laser feedback interferometry analysis can achieve a precise three-dimensional representation of the body of the user with an exact description of the individual body parts and precise representations of movements of the body.

According to one example embodiment of the present invention, the pose model information comprises information regarding one or a plurality of poses from the following list: finger pose, hand pose, forearm pose, arm pose, shoulder pose, upper body pose, lower body pose, overall body pose, movement poses comprising sitting pose, standing pose, lying pose, walking pose, running pose, jumping pose, dancing pose, arm movement pose, hand movement pose.

This can achieve the technical advantage that a multiplicity of different poses of the user can be determined.

Provided according to a third aspect of the present invention is a computer program product comprising instructions that, when the program is executed by a data processing unit, cause the latter to perform the method for determining a pose of a user according to one of the above-described embodiments of the present invention.

Exemplary embodiments of the present invention are explained with reference to the figures.

### BRIEF DESCRIPTION OF THE DRAWINGS

FIG. 1 shows a schematic representation of a glasses device according to one example embodiment of the present invention.

FIG. 2 shows a schematic representation of a user with a glasses device according to one example embodiment of the present invention.

FIG. 3 shows a schematic side view of a user with a glasses device according to one example embodiment of the present invention.

FIG. 4 shows a schematic top view of a user with a glasses device according to one example embodiment of the present invention.

FIG. 5 shows a schematic side view of a user with a glasses device according to one example embodiment of the present invention.

FIG. 6 shows a schematic representation of a sensor arrangement integrated into a temple element of a glasses device, according to one example embodiment of the present invention.

FIG. 7 shows a further schematic representation of a sensor arrangement integrated into a temple element of a glasses device, according to one example embodiment of the present invention.

FIG. 8 shows a further schematic representation of a sensor arrangement according to one example embodiment of the present invention.

FIG. 9 shows a flow chart of a method for determining a pose, according to one example embodiment of the present invention.

FIG. 10 shows a graphical representation of a computer program product, according to an example embodiment of the present invention.

### DETAILED DESCRIPTION OF EXAMPLE EMBODIMENTS

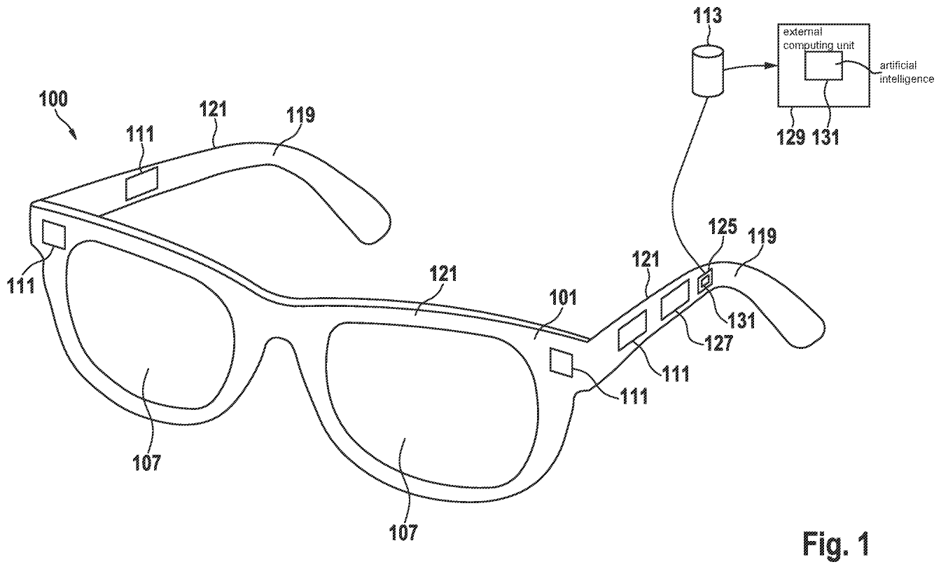

FIG. 1 shows a schematic representation of a glasses device 100 according to one embodiment of the present invention.

In the embodiment shown, the glasses device 100 comprises a frame structure 101 and two temple elements 119 pivotally fixed to the frame structure. Two vision elements 107 are arranged in the frame structure 101.

Two sensor arrangements 111 are furthermore arranged in the frame structure 101. A sensor arrangement 111 is also arranged in each of the two temple elements 119.

In the embodiment shown, a computing unit 125 with an artificial intelligence 131 installed thereon is furthermore formed in at least one temple element 119. Moreover, the temple unit 119 is formed as a transmitting/receiving unit 127.

The sensor arrangements 111 are configured to capture sensor data. The sensor devices 111 are in this case arranged in such a way that, when a user wears the glasses device 100, the sensor data captured by the sensor arrangements 111 represent subareas of a body of the user and are thus suitable to perform a pose determination of a pose of the user based on the sensor data 113.

For this purpose, the sensor arrangements 111 can comprise various types of sensors, such as camera sensors, stereo camera sensors, ultrasonic sensors, LiDAR sensors, edge emitter laser assemblies, or laser feedback interferometry sensors. The sensor data used are in this case configured, without exception, to represent parts of the body of the user while the user wears the glasses device 100, so that a corresponding pose determination can be carried out based on the sensor data 113.

The pose determination can be performed according to the embodiment shown by a correspondingly trained artificial intelligence 131. The artificial intelligence can in this case be trained to ascertain various poses of the user based on the corresponding sensor data 113.

For this purpose, the artificial intelligence 131 can be installed and executed on a computing unit 125. The computing unit 125 can be integrated into the glasses assembly 100. In the embodiment shown, the computing unit 125 is integrated into a temple element 119 of the glasses device. The pose determination can thus be carried out by the glasses device 100 while the user wears the latter.

Alternatively or additionally, the pose determination can be carried out by an external computing unit 129. For this purpose, the sensor data 113 of the sensor arrangements 111 can be transmitted to the external computing unit 129 by a transmitting/receiving unit 127 of the glasses device 100. The external computing unit 131 can subsequently perform a corresponding pose determination based on the transmitted sensor data 113. In the embodiment shown, a correspondingly trained artificial intelligence 131 is also installed on the external computing unit 129 for this purpose.

For example, the external computing unit 129 can be provided by a mobile device of the user or by an external server architecture.

The data transmission of the sensor data 113 can in this case be realized by means of wireless data transmission.

In the embodiment shown, the sensor arrangements 111, the transmitting/receiving unit 127 and the computing unit 131 are integrated into a support body 121 of both the frame structure 101 and the temple elements 127.

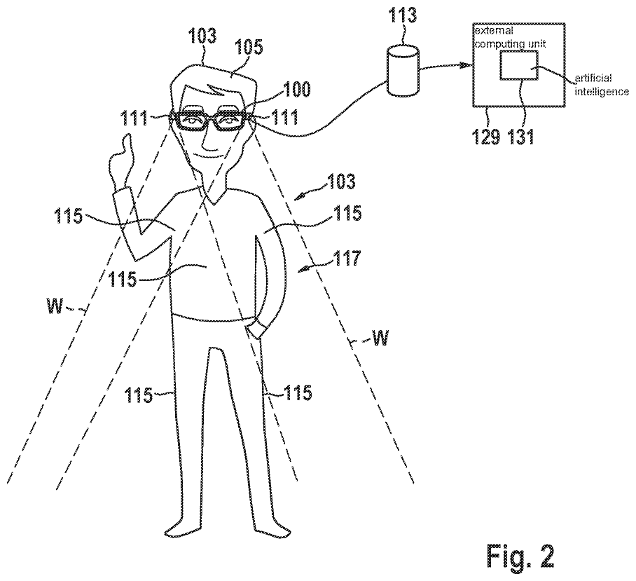

The glasses device 100 is designed as a pair of glasses in the embodiment shown. Alternatively, the glasses device can be designed as a pair of sunglasses, reading glasses, occupational safety glasses, ski glasses, swim goggles, or diving goggles. FIG. 2 shows a schematic representation of a user 105 with a glasses device 100 according to one embodiment.

In the embodiment shown, the glasses device 100 comprises two sensor arrangements 111 arranged on the frame structure 101. The sensor arrangements 111 are in this case oriented in such a way that the effective ranges W of the two sensor arrangements 111 are each directed downward so that, when the user wears the glasses device 100, the sensor data 113 captured according to the effective ranges W of the sensor arrangements 111 primarily represent the body of the user 105 below a head 103 of the user 105. In the embodiment shown, various subareas 115 of the body 117 of the user 105 are represented. In particular, the subareas 115 of the shoulders, arms, hands, upper body, legs, and feet of the user wearing the glasses device 100 are represented by the sensor data 113.

As already described with respect to FIG. 1, the sensor data 113 can be transmitted to an external computing unit 129 for further processing and for determining the poses of the user 105. Alternatively, the pose determination can be carried out directly within the glasses device 100.

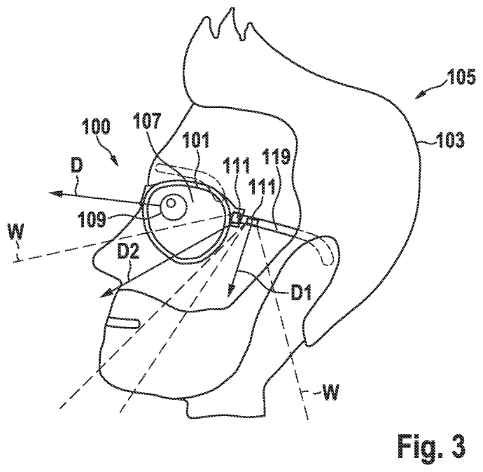

FIG. 3 shows a schematic side view of a user 105 with a glasses device 100 according to one embodiment.

In the embodiment shown, the glasses device 100 comprises a sensor arrangement 111 formed on the frame structure 101 and a sensor arrangement 111 arranged in a temple element 119. The sensor arrangement 111 of the frame structure 101 has an orientation D2 running partially in a viewing direction D of the glasses device 100. The sensor arrangement 111 of the temple element 119, on the other hand, has an orientation D1, which is primarily directed downward toward the body of the user 105 and thus runs almost perpendicularly to the viewing direction D of the user 105.

The two effective ranges W of the sensor arrangements 111 are thus oriented according to the orientations D1, D2 partially in the direction of the viewing direction D and partially almost perpendicularly to the viewing direction D.

According to the present invention, the viewing direction D is defined by the vision elements 107 of the glasses device 100.

According to the present invention, the orientations D1, D2 of the sensor arrangements 111 are at least partially oriented at an angle relative to the viewing direction D in order to thereby ensure that, when a user wears the glasses device, the sensor data of the sensor arrangements 111 represent subareas 115 of the body 117 of the user 105, such as shoulders, arms, hands, upper body, legs or feet. As a result of the sensor data 113 of the sensor arrangements 111 representing the mentioned subareas 115, a precise pose determination of a pose of the user 105 can thus be effected.

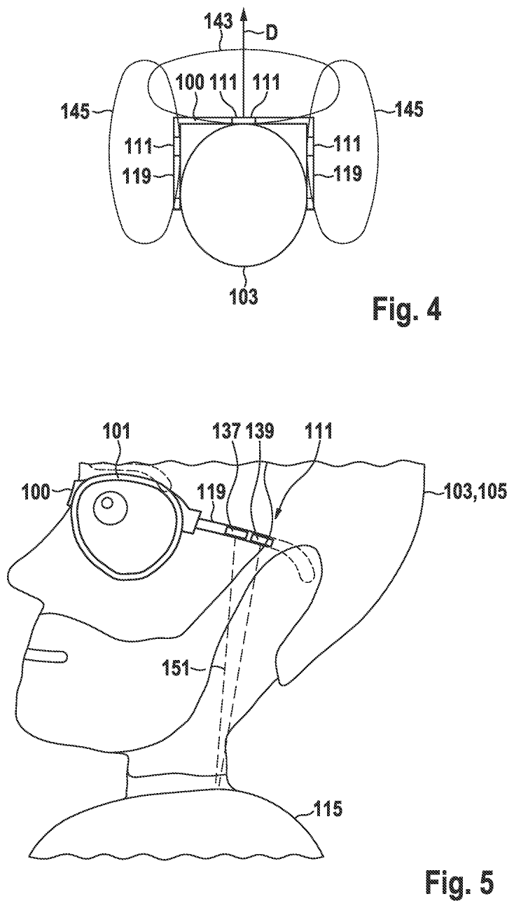

FIG. 4 shows a schematic top view of a user 105 with a glasses device 100 according to one embodiment.

FIG. 4 shows a top view of a head 103 of a user 105. A glasses device 100 is arranged on the head 103. The glasses device 100 has a sensor arrangement 111 on the frame structure 101. A sensor arrangement 111 is also formed on each of the two temple elements 119.

In the embodiment shown, the sensor arrangement 111 arranged on the frame structure 101 comprises a frontal effective range 143.

The frontal effective range 143 is in this case arranged in front of the face and the front body area of the user 105 and runs at least partially in the direction of the viewing direction D defined by the vision elements 107 of the glasses device 100.

The two sensor arrangements 111 arranged laterally on the temple elements 119 each have a lateral effective range 145. The two lateral effective ranges 145 are each arranged laterally next to the head 103.

By means of the frontal and lateral effective ranges 143, 145 shown by way of example, body areas of a body of the user 105 both in the frontal region, for example the chest or front torso, and in the lateral region, for example the shoulders and arms, can be represented by the sensor data of the sensor arrangements 111.

The design of the effective ranges 143, 145 in FIG. 4 is merely by way of example.

FIG. 5 shows a schematic side view of a user 105 with a glasses device 100 according to one embodiment.

In the embodiment shown, the glasses device 100 comprises a sensor arrangement 111 on a temple element 119. The sensor arrangement 111 shown comprises, in the embodiment shown, an edge emitter laser 137 and a camera sensor 139.

The edge emitter laser 137 is configured to transmit and receive laser light 151, for example infrared laser light; based on the received laser signals reflected by various body parts of the user, for example by a shoulder of the user in the embodiment shown, distance or movement information of the respective reflective body part can be ascertained. In combination with the image data of the camera sensor 139, three-dimensional information of the reflective body parts or subareas 115 of the body 117 of the user 105 can thus be ascertained. The three-dimensional representation of the various subareas of the body can be used for a pose determination.

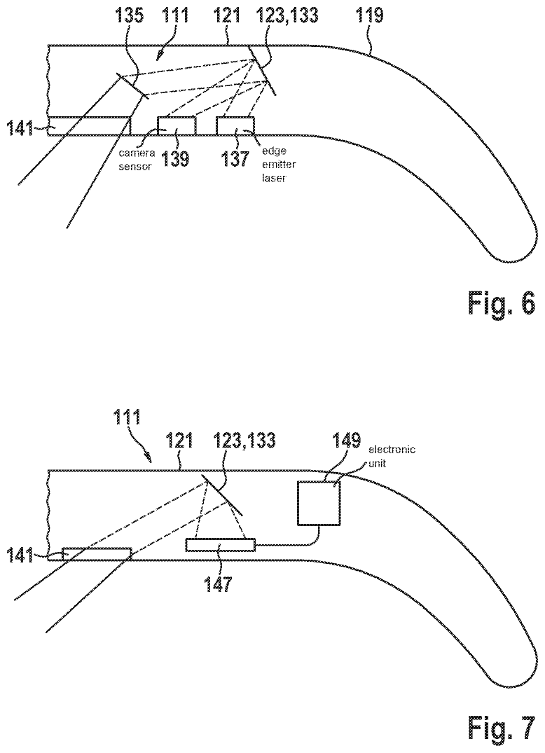

FIG. 6 shows a schematic representation of a sensor arrangement 111 integrated into a temple element 119 of a glasses device 100, according to one embodiment.

In the embodiment shown, the sensor arrangement 111 again comprises an edge emitter laser 137 and a camera sensor 139. The edge emitter laser 137 and the camera sensor 139 are arranged within the support body 121 of the temple element 119. Furthermore, a deflection unit 123 is formed in the interior of the support body 121. In the embodiment shown, the deflection unit 123 is designed as a mirror element or a holographic optical element 133. Furthermore, the sensor arrangement 111 comprises an optical element 135, which can be designed as a lens or aperture, for example. Moreover, an optical window 141 is formed on the support body 121.

Via the optical window, laser signals of the edge emitter laser 137 can be conducted out of the support body 121. Moreover, the laser signals reflected by various subareas 115 of the body 117 of the user 105 can be conducted via the optical window 141 back to the edge emitter laser 137. Moreover, via the deflection unit 123, the optical elements 135, and the optical window 141, the camera sensor 139 is able to create image captures of the body of the user 105.

FIG. 7 shows a further schematic representation of a sensor arrangement 111 integrated into a temple element 119 of a glasses device 100, according to one embodiment.

In the embodiment shown, the sensor arrangement 111 comprises a laser feedback interferometry sensor 147 arranged in the support body 121. Furthermore, the sensor arrangement 111 comprises an electronic unit 149, the deflection unit 123, the optical window 141. Via the deflection unit 123 and the optical window 141, the laser feedback interferometry sensor 147 is configured to send laser signals out of the support body 121 and to receive laser signals reflected by the environment. A corresponding laser feedback interferometry analysis can be carried out via the electronic unit 149. By means of this analysis, distance or velocity information regarding the laser signals of the laser feedback interferometry sensor 147 can be ascertained.

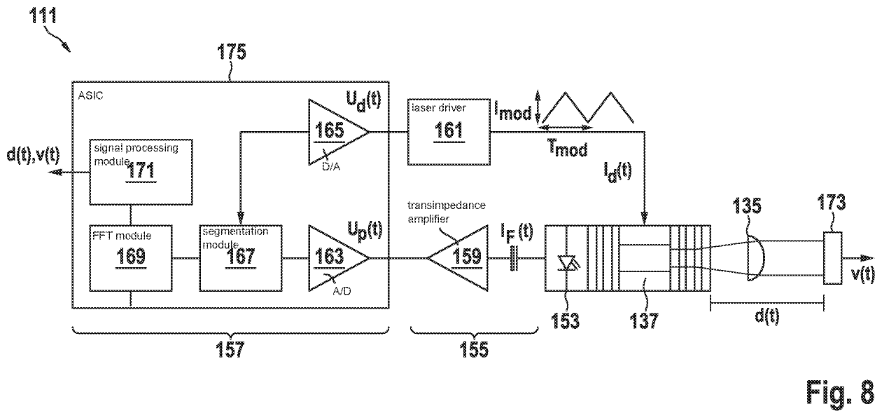

FIG. 8 shows a further schematic representation of a sensor arrangement 111 according to one embodiment.

In the embodiment shown, the sensor arrangement 111 comprises an edge emitter laser 137 comprising a laser diode 153 and an optical element 135. Furthermore, the sensor arrangement 111 comprises a processing section with an analog domain 155 and a digital domain 157. The analog domain 155 comprises a transimpedance amplifier 159 and a laser driver 161. The digital domain 157 comprises an analog-to-digital converter 163, a digital-to-analog converter 165, a segmentation module 167, a fast Fourier transformation module 169, and a signal processing module 171, which are each arranged on an ASIC 175.

The sensor arrangement 111 designed in this way is able to ascertain distance information and/or velocity information of a reflective object 173.

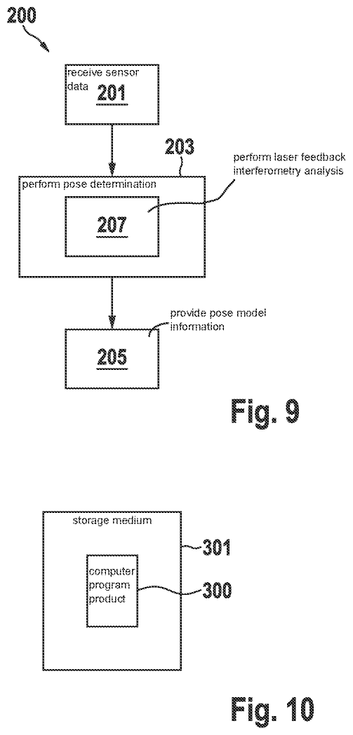

FIG. 9 shows a flow chart of a method 200 for determining a pose, according to one embodiment.

According to the present invention, for determining a pose of a user 105 of the glasses device 100, sensor data 113 of at least one sensor arrangement 111 of the glasses device 100 are first received in a method step 201. The sensor data 113 in this case represent at least one subarea 115 of the body 117 of the user 105 of the glasses device 100. Furthermore, the sensor data 113 were captured while the user 105 wore the glasses device 100.

In a method step 203, a pose determination is performed based on the sensor data 113 and pose model information regarding a pose of the user 105 is ascertained.

In the embodiment shown, the sensor arrangement 111 comprises a laser feedback interferometry sensor. In order to perform the pose determination, in a further method step 207, a laser feedback interferometry analysis is thus performed and distance values or velocity values of at least one subarea of the body of the user 105 of the subareas of the body of the user 105 represented by the sensor data 113 are thus ascertained.

In a further method step 205, the pose model information is provided.

According to one embodiment, in addition to the use of laser sensors, three-dimensional depth profiles of the represented body parts of the body of the user can also be generated via triangulation via a plurality of camera sensors.

According to one embodiment, the pose model information comprises information regarding the poses: finger pose, hand pose, forearm pose, arm pose, shoulder pose, upper body pose, lower body pose, overall body pose, movement pose comprising sitting pose, standing pose, lying pose, walking pose, running pose, jumping pose, dancing pose, arm movement pose, hand movement pose or other poses of a human body.

According to one embodiment, the deflection unit 123 can be designed as a face array or static grid. The deflection unit 123 can furthermore be designed to represent the sensor signals in various spatial directions.

FIG. 10 shows a schematic representation of a computer program product 300 comprising instructions that, when the program is executed by a computing unit, cause the latter to perform the method 200 for determining a pose.

The computer program product 300 is stored on a storage medium 301 in the embodiment shown. The storage medium 301 can in this case be any storage medium from the related art.

What is claimed is:

1. A glasses device, comprising:
a frame structure configured to fix the glasses device to a head of a user;
at least one at least partially transparent vision element, which can be positioned in front of at least one eye of the user and through which the user can look; and
at least one sensor arrangement arranged on the frame structure, wherein the sensor arrangement is configured to capture sensor data while the user wears the glasses device, wherein the sensor data at least partially represent at least one subarea of a body of the user during the wearing of the glasses device, and wherein a pose determination of a pose of the user can be carried out based on the sensor data.

2. The glasses device according to claim 1, wherein the subarea of the body of the user includes one or more from the following list: upper body, shoulder, arm, upper arm, forearm, hand, torso, leg, thigh, lower leg, foot.

3. The glasses device according to claim 1, wherein the sensor arrangement is at least partially oriented in a viewing direction of the glasses device defined by the vision element and/or at an angle to the viewing direction.

4. The glasses device according to claim 1, wherein the frame structure includes at least one temple element for fixing the glasses device to an ear of the user, and wherein the at least one sensor arrangement is arranged at least partially on the temple element.

5. The glasses device according to claim 1, wherein the at least one sensor arrangement is at least partially integrated into a support body of the frame structure and/or of the temple element.

6. The glasses device according to claim 1, wherein the sensor arrangement further includes at least one deflection device, and wherein an orientation of the sensor arrangement can be varied via the deflection device.

7. The glasses device according to claim 1, wherein the sensor arrangement includes one or more from the following list: camera sensor, stereo camera sensor, ultrasonic sensor, LiDAR sensor, edge emitter laser assembly, laser feedback interferometry sensor.

8. The glasses device according to claim 1, wherein the glasses device is configured as one from the following list: glasses, reading glasses, sunglasses, safety glasses, ski glasses, swim goggles, diving goggles.

9. The glasses device according to claim 1, further comprising:
a computing unit configured to ascertain the pose determination of the pose of the user based on the sensor data of the sensor arrangement.

10. The glasses device according to claim 1, further comprising:
a transmitting/receiving unit configured to transmit the sensor data of the sensor arrangement to an external computing unit for a pose determination.

11. The glasses device according to claim 9, wherein a trained artificial intelligence is formed on the computing unit, and wherein the trained artificial intelligence is configured to ascertain the pose of the user based on the sensor data.

12. A method for determining a pose of a user, comprising the following steps:
receiving sensor data of at least one sensor arrangement of a glasses device, wherein the sensor data at least partially represent at least one subarea of a body of a user of the glasses device, and wherein the sensor data were captured while the user wore the glasses device;
performing a pose determination based on the sensor data and determining pose model information regarding a pose of the user of the glasses device; and
providing the pose model information.

13. The method according to claim 12, wherein the glasses device includes:

14. A method according to claim 12, wherein the received sensor data include lidar data of at least one laser feedback interferometry sensor, and wherein performing of the pose determination includes:
performing a laser feedback interferometry analysis and determining distance values and/or velocity values of at least subareas of the subareas of the body of the user represented by the sensor data.

15. The method according to claim 12, wherein the pose model information includes information regarding one or a plurality of the poses from the following list: finger pose, hand pose, forearm pose, arm pose, shoulder pose, upper body pose, lower body pose, overall body pose, movement poses comprising sitting pose, standing pose, lying pose, walking pose, running pose, jumping pose, dancing pose, arm movement pose, hand movement pose.

16. A non-transitory computer-readable storage medium on which is stored a computer program including instructions for determining a pose of a user, the instructions, when executed by a processing unit, causing the processing unit to perform the following steps:
receiving sensor data of at least one sensor arrangement of a glasses device, wherein the sensor data at least partially represent at least one subarea of a body of a user of the glasses device, and wherein the sensor data were captured while the user wore the glasses device;
performing a pose determination based on the sensor data and determining pose model information regarding a pose of the user of the glasses device; and
providing the pose model information.
